(19) United States
(12) Patent Application Publication
(10) Pub. No.: US 2003/0074211 A1
(43) Pub. Date: Apr. 17, 2003

(54) Online real-time corporate business planning system and method

(75) Inventor: Wang Yu Lun, Taipei (TW)

Correspondence Address: BACON & THOMAS, PLLC, 625 SLATERS LANE, FOURTH FLOOR, ALEXANDRIA, VA, 22314

(73) Assignee: Easy 221 Consulting Inc., Taipei (TW)

(21) Appl. No.: 10/026,744

(22) Filed: Dec. 27, 2001

(30) Foreign Application Priority Data
Oct. 15, 2001 (TW) 090125450

(51) Int. Cl. G06F 17/60

(52) U.S. Cl. 705/1

(57) ABSTRACT

The online corporate business planning and financial report forecast system and method of the invention are implemented in a network transmission environment. By building a professional online consulting website and allowing real-time interactions with users through the network, the system lets user enter financial data, prospects, and goals of the corporation for the next few years according to questions on the website to obtain online real-time corporate business plans and forecast financial reports. The invention further includes a business planning system server and a business planning system database so that the plans and reports thus obtained can be compared with other companies within the same industry. From the comparison, corporate financial distributions can be modified and optimized. The invention also ensures efficiency and privacy in obtaining corporate business plans and forecast financial reports.

### BACKGROUND OF THE INVENTION

1. Field of Invention

The invention relates to a system and method for corporate business planning. More particularly, the invention relates to a system and method that allows corporate owners or individuals to complete corporate future business planning and forecast balance sheets, income statements, and cash-flow statements simply through web page tables on the Internet at any time and any place in order to obtain immediate analysis reports in real time.

2. Related Art

For a corporation, a business plan is the blueprint for starting a business and a basis for raising funds. In fact, setting up a business plan does not guarantee the success of the business; and running a business without any business plan does not necessarily mean the business will fail, either. However, performing commercial activities without a business plan is similar to sailing without a destination. There may be a lot of unexpected incidents. Therefore, setting up a business plan allows one to think in advance all possible situations that may happen to the business and make appropriate preparations. Such simulations and practices can greatly increase the success probability of the corporation by determining a prudent direction and method before the business starts.

Investment means that one first puts in a certain amount of money and expect profits from future operations of the business. A correct investment analysis can prevent the corporation from making incorrect or blind investments and thus properly manage subsequent investments. Investment is also an important means for people to manage their money nowadays. Such a method may geneuate greater profits than conventional money management or even help a corporation or a person create a completely new field in business; it, however, has a larger risk in contrast. Therefore, one should have some knowledge about hedging before investing. Financial analysis is a major method in hedging because financial analysis forces investors to collect related information to make the investment plan more concrete. Moreover, a long period of financial analysis enables an investor to control the progress and record in the investments. When the investor learns of an increase in investment risks, he or she then knows how to best deal with them.

Most corporate businesses are said to prepare simple budget plans or many of them do not have budget plans at allbut never the less run pretty well. If one draws the conclusion from this phenomenon that budget planning is not very important, he or she may be only partially right. If the corporate manager is an expert and makes important decisions on his or her own, then whether there is a formal budget plan or not indeed is not crucial. This is because the owner already has a good plan in mind. However, in starting a new business, the manager is confronted with an unfamiliar and rapidly changing environment. Therefore, without the help of a budget plan, the business starter may well get lost.

not having a budget plan is equivalent to not having a concrete management plan in the invested business. One does not know how much money the business will make or lose, which is very dangerous. Honestly speaking, losing money for a period of time is normal for a new business. The essential questions are how much more it will lose and how much longer one should keep investing? Is there any plan or preparation to turn the losing situation into a winning one? One document for such preparation is the budget plan. Consequently, not knowing how to making a budget plan is equivalent to investing in a business without a concrete management plan.

The budget is an estimate in advance. One estimates how much the company will make or lose provided the invested corporation is running under the same conditions. One estimates how much more capital the corporation still needs from investors. One also estimates which part of the company should be reinforced and which costs should be saved once the balance becomes positive. Only after calculating such estimates will the corporate owner be prepared, knowing how much money he or she needs, what is needed in management, and whether this business should beabandoned.

Historical data and management environment evaluations for the new fiscal year can forecast possible profits and losses and expected capital for the coming year. This budget plan indicates the standards the corporation can possibly achieve. It is normally completed by financial and other departments.

In fact, corporate management needs a plan. The plan is the beginning of a business. Even a small business also needs a plan, though the plan is not necessarily put into a real document but may merely exist in the boss' head. If a corporation has careful planning, from corporate management goals, prospects, sales plans, production plans, purchase plans, R&D plans, recruit plans, to expenses and cash plans, then forecast finance reports including asset liabilities, balance sheets, and cash flows can be organized. Thus, the corporate owner knows whether the plans are feasible.

With reference to FIG. 1, most medium and small businesses hire accountants or administrative secretaries who are not professionally trained to write up the business plan, investment analysis and budget plan due to the limitation of capital and ignorance of the importance of these plans. Some careful managers 1 may hire experts (accountants and finance analysts) as consultants 2. When writing the business plans, these professional consultants 2 are consulted to provide professional opinions. Furthermore, some companies also ask professional consultants to write the business plans, investment analyses and budget plans.

No matter which method the corporation takes, it is still hard to achieve the goals of a good business plan, a correct investment analysis, and a fine budget plan. The plan documents competed by untrained people may not satisfy the requirements of the corporate owner or are may not be objective enough. If professional people are hired to write the plan documents, the corporate has to provide its internal, confidential documents to them without reservation for making plans. However, it is risky to do so because the confidential documents may be stolen and thus influence the future development of the company. If some secret documents are purposely kept confidential, it is difficult for the consultants toperform correct analyses. This may result in a flawed plan and greatly influence the future of the business. Moreover, recruiting a professional consultant to complete the plans also requires time. This delay causes the company lose business opportunities and thus possible profits.

Computerization is the trend nowadays. Each business has to understand its necessity. If a web site manager can communicate with other people about professional questions online through proper designs of web page contents, it will save a lot of consulting expenses. Furthermore, the website runs 24 hours per day. It can achieve the goals of real-time online business planning and consulting. If medium small corporate business owners can properly use the website on the Internet to make business plans, investment analyse, and budget plans, it will be of great help to expand businesses and to raise funds according to the plans and analyses.

### SUMMARY OF THE INVENTION

An objective of the invention is to provide a system method used in a network transmission environment that has real-time interactions with users through the Internet and allows the users to enter finance data of the business in the past years according to the questions provided on web page tables. The users can immediately obtain a corporate business plan and a forecast finance report in real time.

Another objective of the invention is to allow a user to enter financial data of the corporation according to the questions listed on a web page table to obtain corporate business planning and forecast financial balance sheets. Such data are presented to the corporate owner in web page format, thereby optimizing the operation strategies.

A further objective of the invention is to allow a user to anonymously enter the above-mentioned data without meeting professional consultants and to make adjustments to entered data at any time, keeping business secret completely confidential.

Whether a corporate owner assigns some unprofessional person in the company to make future business planning and forecast financial reports or hire professional consultants to write various plans, it is highly probable that the business plans and forecast reports are not complete and clear enough to point out a direction for the corporate owner to follow. There is also a risk for the corporation in releasing its internal secrets. Furthermore, in the case of hiring a consultant to write plans, the consultant has to revise the plans repeatedly once the corporate changes its data, making the time schedule hard to control.

Therefore, the invention proposes an interactive inquiry function on the Internet for corporate owners and individuals to draft the business plans and forecast financial reports (e.g. business plans, investment analysis plans, and budget plans). The invention collects professional data and knowledge from different businesses and builds a system database. The Q&A interactions on web page tables guide users to think about how to make business plans, investment analyses, and forecast calculations. After the corporate owner or individual enters the needed data for the Q&A on the web page tables in the disclosed method, the system takes the forecast values or assumption values entered by the user to make inferences and analyses based upon the experience of professional consultants in different industries and future market data. If the obtained results are not satisfactory or different from the expectations of the corporate owner or individual, then one can modify the entered data to adjust the business plans and forecast financial reports.

### BRIEF DESCRIPTION OF THE DRAWINGS

The present invention will become more fully understood from the detailed description given hereinbelow, such description being by way of illustration only and thus is not limitative of the present invention, wherein:

FIG. 1 is a schematic view of interactions between a corporate owner and a professional consultant in the prior art;

FIG. 2 shows a structure of the environment for the disclosed online real-time corporate business planning system;

FIG. 3 is a flowchart of the disclosed online corporate business planning method;

FIG. 4 is a business plan document-catalog list presented in web page format in an embodiment of the invention; and

FIGS. 5A, 5B, and 5C show a business plan document-finance plans and investment profit analysis table in the above-mentioned embodiment.

### DETAILED DESCRIPTION OF THE INVENTION

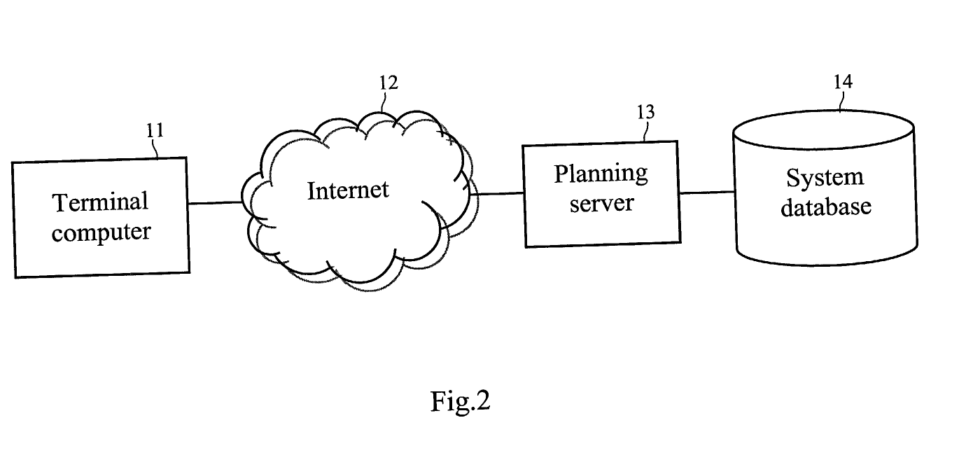

Since the Internet is very popular, almost all corporation and individuals can use computers to connect to the network. Therefore, the invention utilizes the convenience of the network to implement the business planning method so that corporate owners and the public can easily access the disclosed method. As shown in FIG. 2, the disclosed corporate business planning system is used in a network transmission environment. It includes a system database 14 and a planning server 13. The planning server 13 sends a series of Q&A interactive web page tables to a terminal computer 11 and obtains text data and numerical data entered through the terminal computer 11 by the member of this business planning system. When a user uses the business planning system, he or she has to answer all questions listed on the web page tables and puts the answers in assigned fields. Once all questions are answered, the user depresses a confirmation button to start a forecast procedure, sending a forecast request message to the planning server 13. Afterwards, the entered data are sent to the planning server 13 through the Internet for performing the forecast procedure. When the planning server 13 completes necessary calculations, analyses, decisions and decoding according to a properly designed program, a complete plan is then formed from the data entered by the user. The planning server 13 presents the plan contents in the web page format on the terminal computer 11 through the Internet 12. The online real-time corporate business planning system allows the user to perform business planning in the above-mentioned mode. Consequently, one can access the planning server 13 and the system database 14 on an unlimited basisthrough the Internet 24 hours a day to figure out an optimal business plan and forecast financial reports for the corporation.

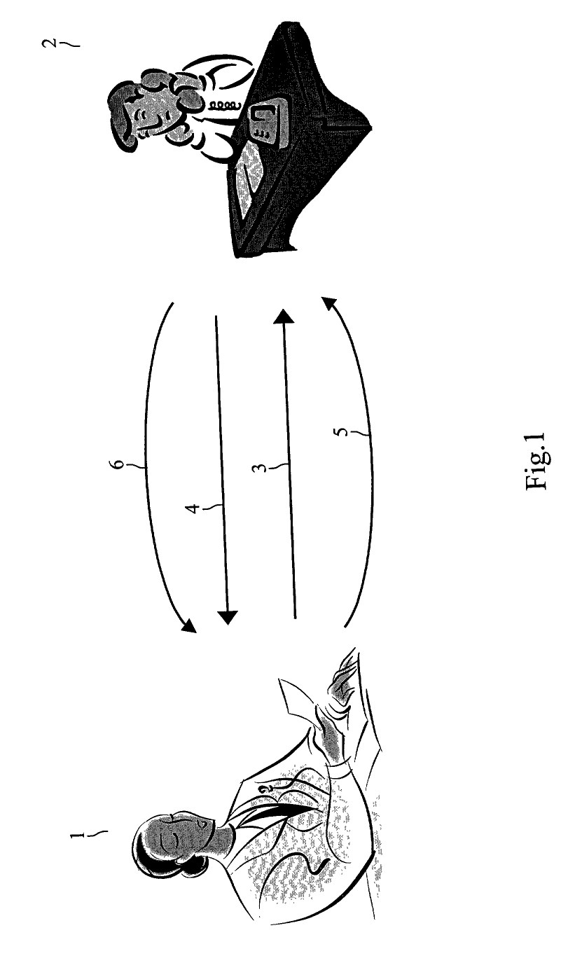

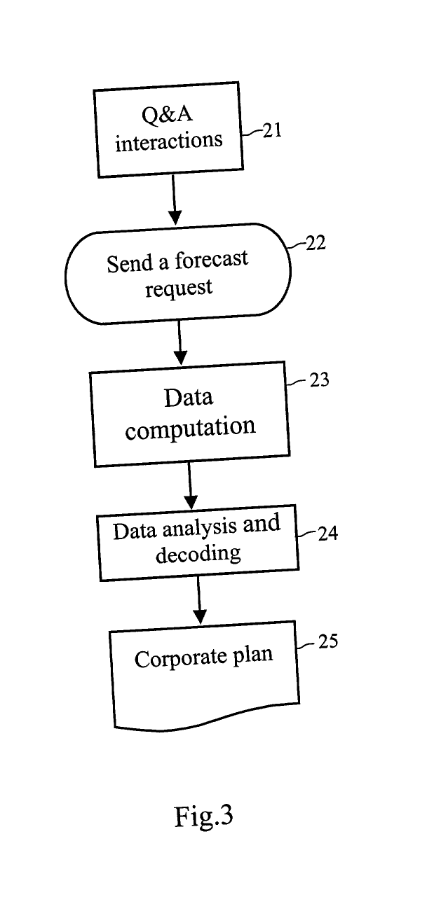

With reference to FIG. 3 and FIG. 1, according to the disclosed business planning method implemented on the online real-time corporate business planning system, a user first needs to complete a login procedure when entering the professional consulting web page to use the business planning system. If this is the first time the user uses this system, he or she has to select a membership class, browse and accept a membership agreement. Afterwards, the user keys in personal data and determines service points to use so that he or she can enter the business planning system to use the online corporate business planning and forecast financial reports according to the points. If the user is already a member and has some service points left, then the user enters the username and password to use the system.

The disclosed online real-time corporate business planning method is used in a network transmission environment and includes the following steps:

Step 21: Q&A Interactions.

After a user log into the system, the planning server 13 generates a series of Q&A interactive web page tables for the user to select desired services. After the selection, the user keys in answers to questions listed on the web pages inside designated data fields. The input fields for these questions include text data and numerical data. Normal text data mainly describe basic data of the company, management notions, business contents, prospects or goals, purposes, etc. Such text descriptions allow people to understand the name, notions, and services of the company. The numerical data are mainly forecast values of the corporate in the future (next 1, 2 or 5 years). The user first keys in these forecast values (such as forecast sales, costs, fees every year in the next 5 years) or data in its financial reports into designated input fields. These data are then used to forecast the corporate business plans and financial reports. Since each corporate has its financial reports, and the data therein provide very good forecast information. Once the user answers all questions, the server then computes to obtain forecast financial data. In addition, step 21 utilizes the Q&A interactions on the web page tables to guide the user in thinking how to make business plans, investment analyses and budget plans. The user can have a good chance to make a thorough consideration in corporate management.

Step 22: Send a Forecast Request.

When the user enters data for all questions on the web page tables, the user can depress a confirmation button on the web page table to send out a forecast request. This forecast request message is sent to the planning server 13, which then performs a forecast procedure. In an embodiment of the invention, the user can press a “Send” button to generate a report. The planning server 13 then takes off a certain number of service points. The user can also press a “Re-enter” button to modify entered data.

Step 23: Data Computation.

The planning server 13 obtains the text data and numerical data entered by the user from the Q&A interactive web page tables. According to predetermined finance formulae, the planning server 13 takes the data entered in step 21 and computes the financial forecast data of the company. For example, the ratio of debts to assets the total debts/total assets, the liquid ratio=liquid assets/liquid debts, the collecting bills forecast sales/(365/the average billing period), etc. These ratios computed by the planning server 13 are then compared with the data in the system database 14 for further analysis, determination, and decoding.

Step 24: Data Analysis and Decoding.

The system database 14 contains data of all industries. These data have been accumulated over many years by professional consulting companies. Having the computed financial forecast values, the planning server 13 starts to make decisions. According to the sales, costs, fees of each year in the next few years, the planning server 13 computes the direction the corporation should follow and obtains a forecast financial report. With financial ratios, the server 13 can further find out forecast future profits and losses, forecast asset/debt tables, forecast cash flows, the net present value (NPV) of the company, the internal reward rate (IRR), and the return period. For example, in an embodiment of the invention, the planning server 13 takes the data entered in step 21 and gets an NVP greater than 0. From the system database 14, one can include “worth investing” opinions in the report. These data and descriptions are integrated and included in the report.

Step 25: Corporate Plan.

With the above simple example, most decisions can be compared and analyzed with other computed data, producing analysis results according to the system database 14. After the data input, computation, analysis and decoding in steps 21, 23 and 24, the planning server 13 combines analysis results in each step into a corporate plan presented in web page format on the terminal computer 11 for the user to download or print. The web page table contents of the corporate plan include: the text data (e.g. text description of company basic data) entered by the user in step 21 and the financial forecast data in step 23. In addition, the plan further includes analysis opinions of various financial data in step 24 and the data provided directly by the system database 14 (such as industry growth analysis, industry trend, and financial analysis opinions, including text descriptions and statistical data). Finally, the corporate plan provides detailed opinions and conclusions to the user according to the analysis. The opinions and conclusions are already stored in the system database 14 in advance. After the analysis of the above steps, data are extracted from the database 14.

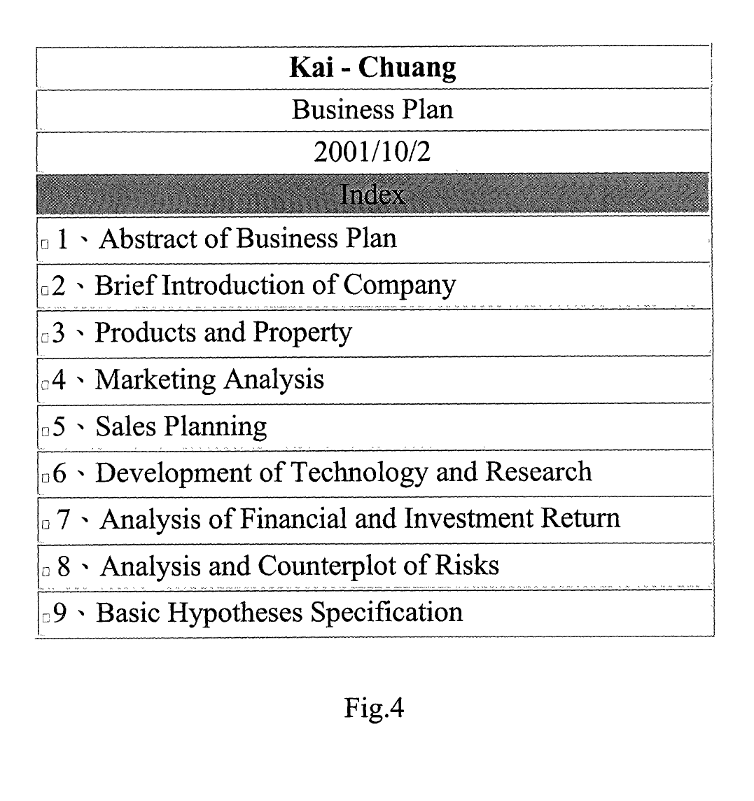

With reference to FIG. 4, in this embodiment of the invention the first web page table shows a catalog list of the business plan. When the user enters answer data to the questions on the Q&A interactive web pages, the user sends out a forecast request message. Through the computation by the planning server 14 and the determination and analysis by the reference system database 14, the user receives a business plan report in a series of web page tables on a terminal computer 11. In this example, the catalog of the business plan report contains nine chapters, including plan abstract, company introduction, products and industry, market analysis, sales plan, R&D, financial plan, investment profit analysis, risk analysis and solutions, basic assumption explanations. Some contents in these chapters are edited from the answers to the questions on the Q&A interactive web pages. These contents are text contents written according to personal ideas. On the other hand, the financial plan and investment profit analysis are obtained according to the data in steps 23 and 24.

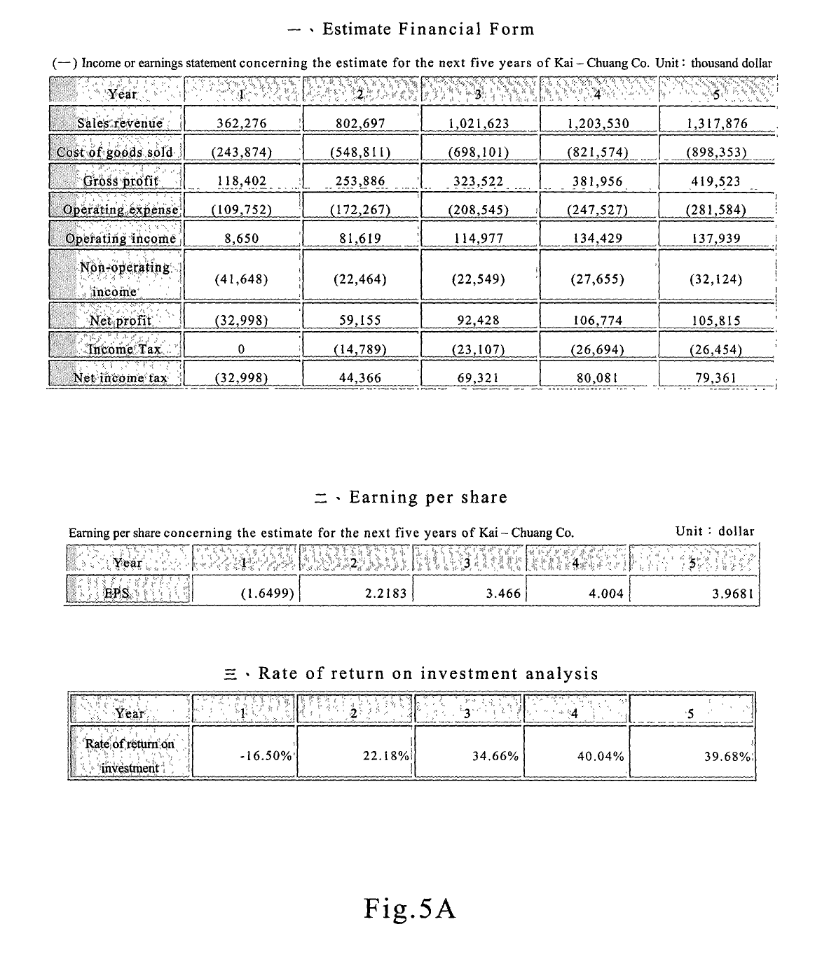

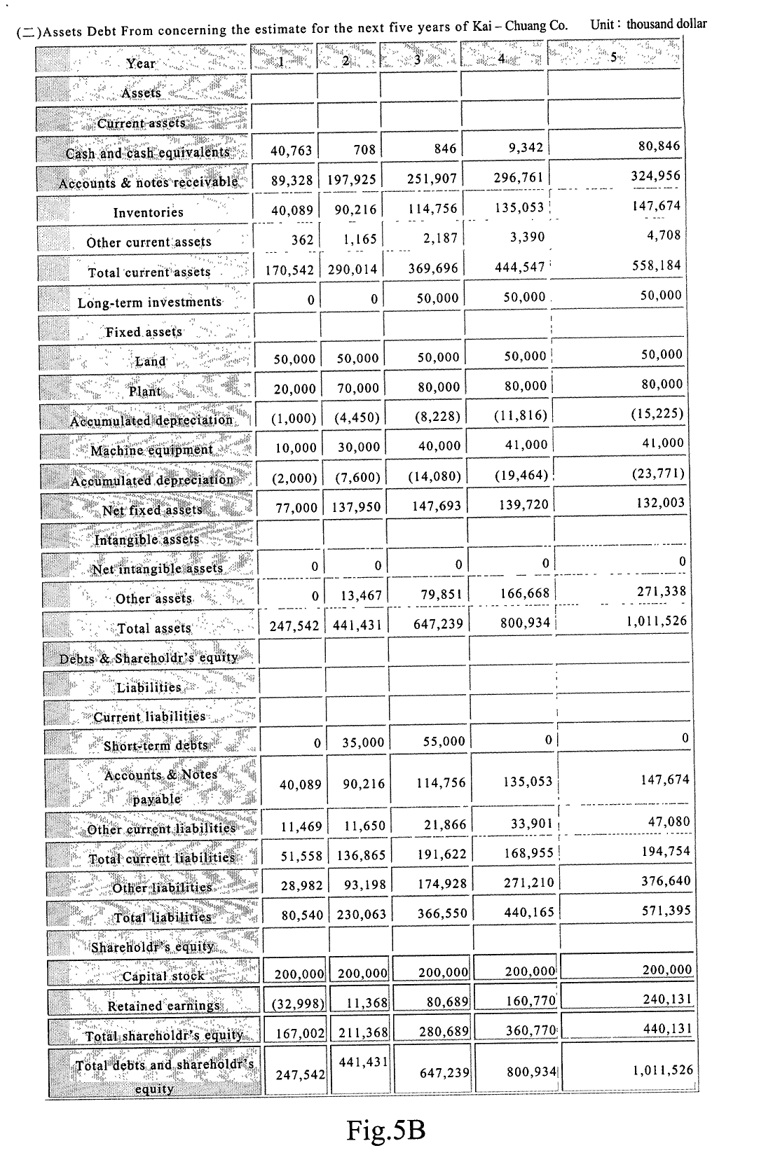

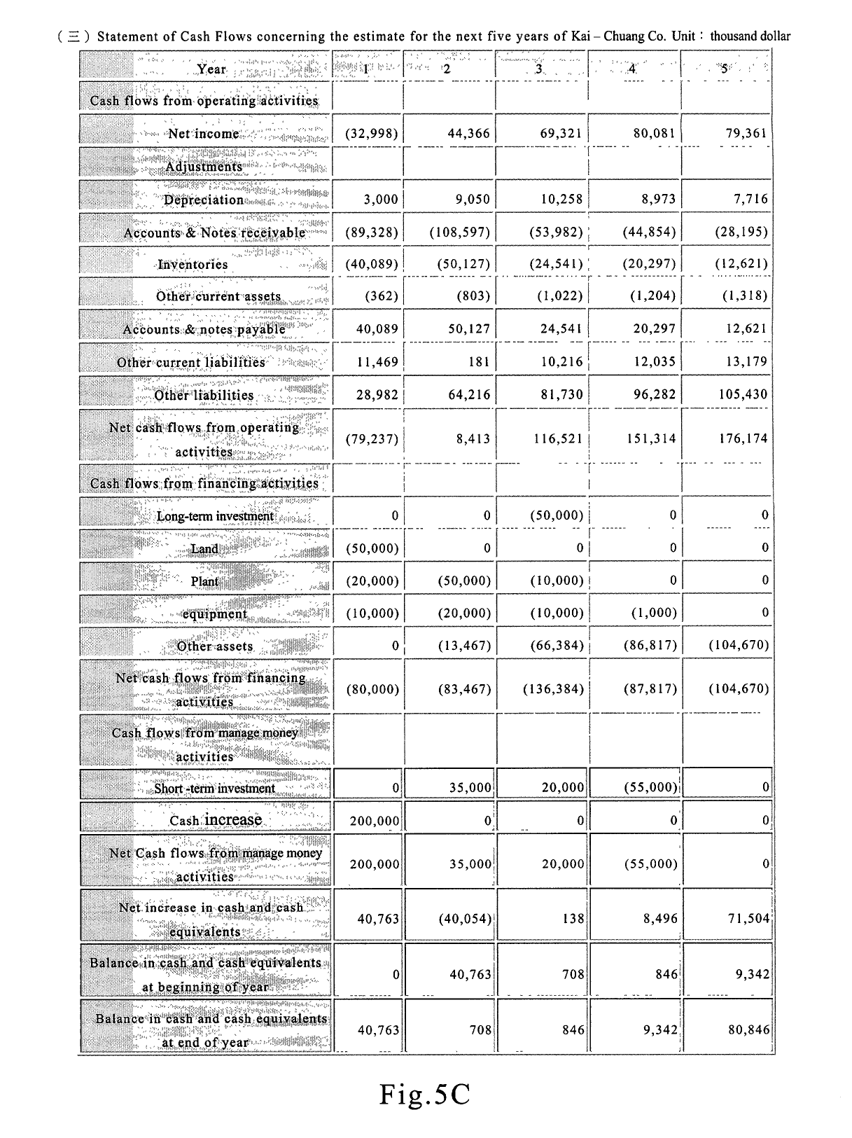

With reference to FIGS. 5A, 5B, and 5C, the web page tables in this example include: a forecast financial report and the earning per share. The forecast financial report includes forecast profits and losses for the next 5 years, the forecast asset/debt table for the next 5 years, and the forecast cash flow table for the next 5 years. The earning per share includes forecast earning per share for the next 5 years. The numerical values in the above-mentioned tables are obtained from steps 23 and 24. One can find out the financial analysis of the corporation in the next 5 years from these numerical values. The corporate owner then uses these numerical values to modify forecast parameters so that the corporate goal is clear and easier to achieve.

### EFFECTS OF THE INVENTION

The online corporate business planning and financial report forecast system and method of the invention has many advantages and features. The disclosed method is implemented in a network transmission environment. By building a professional online consulting website and real-time interactions with users through the network, the user can enter financial data of the corporation for the next few years according to questions on the website. It saves users time in obtaining corporate business plans and forecast financial reports. Furthermore, the invention uses a business planning system database to compare the financial ratios of the corporation with other companies in the same industry. The comparison results are used to make proper corporate business plans and forecast financial reports so as to modify and optimize management strategies. In addition, the user performs the above data input anonymously without directly interacting with consultants. The user can modify the entered data at any time. This feature keeps the commercial secrets of the corporation completely confidential.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. An online corporate business planning method used in a network transmission environment, which includes the steps of:
generating a series of web page tables whose contents include a plurality of finance-related questions and corresponding input fields;
computing forecast financial data according to the entered data in the input fields and predetermined formulae;
obtaining analysis opinions corresponding to the forecast financial data and the data in the input fields according to a system database; and
generating a plan report in web page format, the plan report including at least the analysis opinions.

2. The method of claim 1, wherein the data entered in the input fields include text data and numerical data.

3. The method of claim 1, wherein the forecast financial data include a net present value (NPV), an internal reward rate (IRR), a profit return period, a debt-to-asset ratio, a liquid ratio, and collecting bills.

4. The method of claim 1, wherein the system database stores financial reference data include current assets, current liabilities, and the corresponding analysis opinions.

5. The method of claim 1, 2, 3, or 4, wherein the data in the plan report include the forecast financial data and financial reference data.

6. The method of claim 1 or 4, wherein the text data in the plan report include the text data provided by the system database.

7. An online corporate business planning system providing a series of Q&A web page tables to a terminal computer through a network transmission environment, the system comprising:
a system database, which stores financial reference data and corresponding analysis opinions; and
a planning server, which provides a plurality of finance-related questions and corresponding input fields on the web page tables and responds to a forecast procedure request from the terminal computer;
wherein the forecast procedure includes the steps of:
computing the forecast financial data according to the data in the input fields;
obtaining the analysis opinions according to the financial reference data in the system database and the data in the input fields;
providing the plan report in web page format on the terminal computer, the plan report including at least the analysis opinions.

8. The system of claim 7, wherein the planning server executes a program to complete the forecast procedure.

9. The system of claim 7, wherein the forecast financial data include a net present value (NPV), an internal reward rate (IRR), a profit return period, a debt-to-asset ratio, a liquid ratio, and collecting bills.

10. The system of claim 7, wherein the data in the plan report presented by the planning server in the web page format include the financial forecast data and the financial reference data.

11. The system of claim 7, wherein the text data in the plan report presented by the planning server in web page format include the text data provided by the system database.

12. An online corporate business planning method used in a network transmission environment for a user to enter data according to a series of finance-related questions in web page tables and to send out a forecast request message, the method comprising the steps of:
computing forecast financial data according to the data entered in the input fields and predetermined financial formulae;
obtaining analysis opinions corresponding to the forecast financial data and the entered data in the input fields according to a system database; and
generating a plan report in web page format, the plan reporting including at least the analysis opinions.

13. The method of claim 12, wherein the forecast financial data include a net present value (NPV), an internal reward rate (IRR), a profit return period, a debt-to-asset ratio, a liquid ratio, and collecting bills.

14. The method of claim 12, wherein the entered data include text data and numerical data.

15. The method of claim 12 or 13, wherein the numerical data in the plan report include the forecast financial data and the financial reference data.

16. The method of claim 12, wherein the text data in the plan report include the text data provided by the system database.
